(19) United States
(12) Patent Application Publication
(10) Pub. No.: US 2019/0171851 A1
(43) Pub. Date: Jun. 6, 2019

(54) TAMPER-PROOF CARD READER WITH A DRILLING PROTECTION COVER

(71) Applicant: ddm hopt + schuler GmbH & Co. KG, Rottweil (DE)

(72) Inventor: Karl-Rudolf Hopt, Rottweil (DE)

(21) Appl. No.: 16/208,865

(22) Filed: Dec. 4, 2018

(30) Foreign Application Priority Data
Dec. 5, 2017 (EP) 17 205 467.8

(51) Int. Cl. G06K 7/00

(52) U.S. Cl. CPC G06K 7/0078; G06K 7/0091; G06K 7/0021

(57) ABSTRACT

A card reader includes a contacting unit for exchanging data with a chip card and a plastic drilling protection cover which covers the contacting unit and has a plastic back-moulded conductor track foil which has an area-covering drilling protection conductor track structure. The drilling protection conductor track structure is applied, in particular printed, onto the conductor track foil using an electrically conductive, transparent ink.

### CROSS-REFERENCE TO RELATED APPLICATIONS

This application claims priority to the European Patent Application No. 17 205 467.8 filed Dec. 5, 2017, the entire contents of which are hereby incorporated in full by this reference.

### DESCRIPTION

### Field of the Invention

The present invention relates to a card reader comprising a contacting unit for exchanging data with a chip card and comprising a plastic drilling protection cover which covers the contacting unit and/or an electronic component, which is connected to said contacting unit, and has a plastic back-moulded conductor track foil which has an area-covering drilling protection conductor track structure, and also to a drilling protection cover composed of plastic, in particular drilling protection hood comprising a plastic back-moulded conductor track foil which has an area-covering drilling protection conductor track structure.

### Background of the Invention

A card reader with a cover of this kind has been disclosed, for example, by EP 3 196 799 A1.

This known card reader has an injection-moulded plastic part in the form of a drilling protection hood with a drilling protection conductor track structure provided on the injection-moulded plastic part. The drilling protection hood is an injection-moulded plastic part, the inner side of which is back-moulded with a two-layer conductor track foil which has an area-covering drilling protection conductor track structure comprising at least one continuous electrical conductor track. The conductor track foil is cohesively connected or fused to the plastic material of the drilling protection hood. If the drilling protection hood is drilled or ground down for manipulation purposes, the continuous conductor track across which current flows during operation is also severed in the process. This interruption in the circuit is identified by a monitoring unit which then no longer permits a reading process and/or takes the contacting unit out of operation.

### SUMMARY OF THE INVENTION

In comparison, the object of the present invention is to make a card reader of the kind mentioned in the introductory part even more secure against manipulation.

According to the invention, this object is achieved in that the drilling protection conductor track structure is applied, in particular printed, onto the conductor track foil using an electrically conductive, transparent ink. The conductor track foil preferably has a single-layer or multi-layer drilling protection conductor track structure which can be in each case applied, in particular printed, onto a carrier layer or an intermediate layer of the conductor track foil.

Transparent or clear electrically conductive ink is sold, for example, by NanoIntegris Technologies, Inc., by Henkel under the name Loctite ECI 5000 and by Applied Ink Solutions under the trade name OrgaCon™. These known inks contain, for example, electrically conductive polymers or silver nanowires. Transparent electrically conductive structures can be printed onto flexible and rigid substrates composed of, for example, PET, PC, PMMA, PI or glass up to a resolution of 100 μm using these electrically conductive inks.

On account of the transparent ink, the conductor track(s) of the printed-on drilling protection conductor track structure is/are not visible to a viewer and, because the intermediate space present between two conductor tracks cannot be identified, therefore even more effectively prevent unnoticed drilling of the drilling protection conductor track structure to which current is applied during operation.

The conductor track foil advantageously forms that side of the drilling protection cover which faces the contacting unit or the electronic component, so that the plastic of the drilling protection cover would first have to be removed (ground down) in order to reach the conductor track foil at all.

The thinner the line thickness of the conductor tracks and the lower the line spacing between the conductor tracks of the drilling protection conductor track structure, the better the protection against manipulation. The at least one drilling protection conductor track advantageously has a line width of at most 0.2 mm, in particular at most 0.15 mm, and a line spacing of at most 0.3 mm, in particular at most 0.2 mm.

The card reader can be mounted on a printed circuit board which makes electrical contact with the drilling protection conductor track structure. The at least one drilling protection conductor track, at its two ends, preferably has in each case electrical connection contacts, in particular in the form of exposed electrical contact areas, which are contacted by electrical mating contacts of the card reader which, in turn, can be connected to a monitoring unit.

The drilling protection cover is particularly preferably designed as a drilling protection hood, the hood inner side or hood outer side of which being formed by the conductor track foil. Up to a card insertion opening through which a chip card is inserted into the card reader up to its data exchange position, the contacting unit can be completely covered by the drilling protection hood.

In a further aspect, the invention also relates to an drilling protection cover composed of plastic for protecting electronic components or data lines, comprising a plastic back-moulded conductor track foil which has an area-covering drilling protection conductor track structure which, according to the invention, is applied, in particular printed, onto the conductor track foil using an electrically conductive, transparent ink. The conductor track foil preferably has a single-layer or multi-layer drilling protection conductor track structure which is in each case applied, in particular printed, onto a carrier layer or an intermediate layer of the conductor track foil.

On account of the transparent ink, the printed-on drilling protection conductor track structure is not visible to a viewer and additionally prevents unnoticed drilling of the drilling protection conductor track structure to which current is applied during operation. Electronic components may be, for example, processors which encrypt the data to be exchanged, and the data lines may be electrical lines.

The drilling protection conductor track structure preferably has at least one drilling protection conductor track with a line thickness of at most 0.2 mm, in particular at most 0.15 mm, and with a line spacing of at most 0.3 mm, in particular at most 0.2 mm. The at least one drilling protection conductor track, at its two ends, can advantageously have in each case electrical connection contacts, in particular in the form of exposed electrical contact areas. The drilling protection cover is particularly preferably designed as an drilling protection hood, the hood inner side and/or hood outer side being formed by the conductor track foil.

Further advantages of the invention are evident from the description, the claims and the drawing. The features mentioned above and those presented further can likewise be used in each case by themselves or as a plurality in any desired combinations. The embodiment shown and described should not be understood as an exhaustive list, but rather is of exemplary character for portraying the invention.

### BRIEF DESCRIPTION OF THE DRAWINGS

In the drawings:

FIG. 1 shows a perspective plan view of the card reader according to the invention which is covered by a drilling protection hood at the bottom;

FIG. 2 shows a perspective plan view of the drilling protection hood shown in FIG. 1, the hood inner side of the said drilling protection hood being formed by a plastic back-moulded conductor track foil;

FIG. 3 shows the conductor track foil from FIG. 2 as a planar foil blank; and

FIGS. 4a, 4b each show a cross section through a conductor track foil with a single-layer drilling protection conductor track structure (FIG. 4a) or with a double-layer drilling protection conductor track structure (FIG. 4b).

### DETAILED DESCRIPTION OF THE PREFERRED EMBODIMENTS

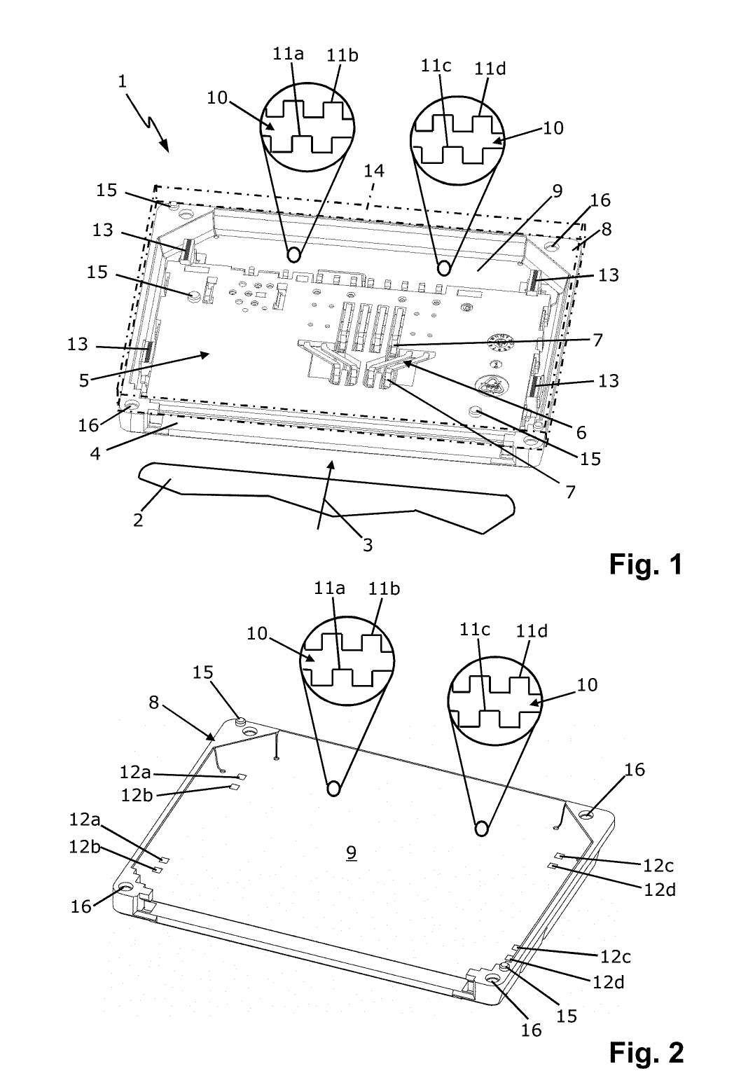

The card reader 1 shown in FIG. 1 is a so-called push/pull card reader in which a chip card 2 is inserted into the card shaft of a contact carrier 5 (or of a card reader housing), up to the data exchange position, by the user in the insertion direction 3 by means of a card insertion opening 4 and is withdrawn from the card reader 1 again by the user after the data exchange operation. The chip card 2 is fitted with a microchip (not shown) for storing data, the contacts of the said microchip being provided as electrical contact fields (not shown) on the card surface. A contacting unit 6 for data exchange with the chip card 2 which is inserted into the card shaft through the card insertion opening 4 is arranged on the contact carrier 5. The contacting unit 6 has a plurality of elastically deformable contact springs 7 which protrude into the card path by way of their free contact ends. The free contact ends of the contact springs 7 are deflected out of the card path by the inserted chip card 2 and make contact with the electrical contact fields of the chip card 2.

The contact carrier 5, together with the contacting unit 6, is covered at the bottom side by a drilling protection cover composed of plastic in the form of an drilling protection hood 8, the hood inner side of which is formed by a plastic back-moulded conductor track foil 9 (FIG. 2). The contact carrier 5 is placed into the drilling protection hood 8 in a precise position and fastened to the said drilling protection hood.

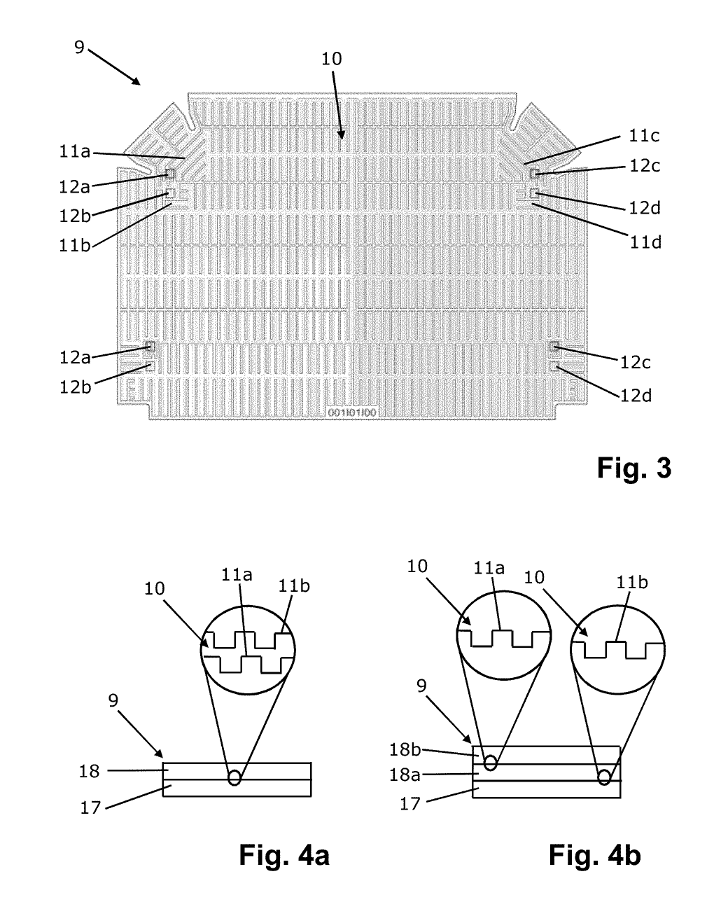

The flexible conductor track foil 9 is shown as a planar foil blank in FIG. 3. At least one area-covering drilling protection conductor track structure 10 in the form of four meandering drilling protection conductor tracks 11a-11d is printed on the conductor track foil 9 using a transparent electrically conductive ink, the line width of which is at most 0.2 mm and the line spacing of which in relation to one another is at most 0.3 mm. On account of the transparent ink, the printed-on drilling protection conductor track structure 10 or its drilling protection conductor tracks 11a-11d are not visible to a viewer. Two drilling protection conductor tracks 11a, 11b are arranged on the left-hand half of FIG. 3 and two drilling protection conductor tracks 11c, 11d are arranged on the right-hand half of the conductor track foil 9.

The erected conductor track foil 9 is placed into the injection-moulding die of the drilling protection hood 8, wherein the side walls of the erected conductor track foil 9 overlap, so that the erected conductor track foil 9 has a gap-free drilling protection conductor track structure 10 in an area-covering manner. During the subsequent in-mould injection-moulding process, the conductor track foil 9 is back-moulded with plastic which then forms the hood inner side, as shown in FIG. 2. Each of the four printed-on drilling protection conductor tracks 11a-11d, at its two ends, has two connection contacts 12a-12d in the form of exposed electrical contact areas on the hood inner side.

Four mating contacts 13 in the form of double contact pads which each make contact with two of the total of eight connection contacts 12a-12d of the drilling protection hood 8 are arranged on the bottom side of the contact carrier 5. The mating contacts 13 are guided laterally beside the contact carrier 5 upwards until they are above the contact carrier 5.

As shown in FIG. 1, the drilling protection hood 8, together with contacting unit 6, is fastened to the bottom side of a printed circuit board 14, indicated using a dashed-dotted line, specifically in an accurate position with the aid of positioning projections 15 on the contact carrier 5 and on the drilling protection hood 8 which engage into corresponding openings of the printed circuit board 14. The drilling protection hood 8 is screwed to the printed circuit board 14 by means of screws which pass through holes 16 in the four corners of the drilling protection hood 8.

As shown in FIG. 4a, the conductor track foil 9 can have a single-layer drilling protection conductor track structure 10 with one or more drilling protection conductor tracks 11a, 11b which are printed onto a carrier layer 17 of the conductor track foil 9 using the transparent ink. The printed side of the carrier layer 17 is covered by a protective layer 18, so that, when injection-moulding the drilling protection hood 8, the drilling protection conductor tracks 11a, 11b are protected and one of the two layers 17, 18 is cohesively connected to the plastic.

In FIG. 4b, the conductor track foil 9 has a double-layer drilling protection conductor track structure 10 with in each case one or more drilling protection conductor tracks 11a, 11b. A drilling protection conductor track 11a (or a plurality thereof) is/are printed onto the carrier layer 17 using the transparent ink, the said drilling protection conductor track or tracks being covered by a first, inner protective layer 18a. A drilling protection conductor track 11b (or a plurality thereof) is/are printed onto this inner protective layer 18a using the transparent ink, the said drilling protection conductor track(s) being covered by a second, outer protective layer 18b. During injection moulding of the drilling protection hood 8, the drilling protection conductor tracks 11a, 11b are protected and the carrier layer 17 or the outer protective layer 18b is cohesively connected to the plastic.

If the drilling protection hood 8 is drilled or ground down from the outside for manipulation purposes, the non-visible drilling protection conductor track structure 10 thereof across which current flows during operation is necessarily destroyed as a result, and consequently the electrical circuit which had been closed up until that point is interrupted. This is identified by a monitoring unit (not shown) of the printed circuit board 14 which then no longer permits a reading process and/or takes the contacting unit 6 out of operation. If the drilling protection hood 8 is lifted off from the printed circuit board 14 for manipulation purposes, the electrical contact between the connection contacts 12a-12d of the drilling protection hood 8 and the mating contacts 13 of the contact carrier 5 is necessarily interrupted as a result, and consequently the electrical circuit which had been closed up until that point is interrupted. This is also identified by the monitoring unit which then no longer permits a reading process and/or takes the contacting unit 6 out of operation. Therefore, unnoticed manipulation of the card reader 1 is not possible, as a result of which a “secure card reader” is provided.

What is claimed is:

1. A card reader comprising:
a contacting unit for exchanging data with a chip card; and
a plastic drilling protection cover which covers the contacting unit and/or an electronic component, which is connected to the said contacting unit, and has a plastic back-moulded conductor track foil which has an area-covering drilling protection conductor track structure;
wherein the drilling protection conductor track structure is applied and/or printed onto the conductor track foil using an electrically conductive, transparent ink.

2. The card reader according to claim 1, wherein the conductor track foil has a single-layer or multi-layer drilling protection conductor track structure which is in each case applied, in particular printed, onto a carrier layer or a protective layer of the conductor track foil.

3. The card reader according to claim 1, wherein the conductor track foil forms that side of the drilling protection cover which faces the contacting unit or the electronic component.

4. The card reader according to claim 1, wherein the drilling protection conductor track structure has at least one drilling protection conductor track with a line thickness of at most 0.2 mm and with a line spacing of at most 0.3 mm.

5. The card reader according to claim 4, wherein the at least one drilling protection conductor track, at its two ends, has in each case electrical connection contacts, in particular in the form of exposed electrical contact areas.

6. The card reader according to claim 5, wherein a contact carrier which carries the contacting unit has electrical mating contacts which make contact with the connection contacts of the at least one drilling protection conductor track.

7. The card reader according to claim 1, wherein the drilling protection cover is designed as a drilling protection hood, the hood inner side or hood outer side of which being formed by the conductor track foil.

8. The card reader according to claim 7, wherein the contacting unit is completely covered by the drilling protection hood up to a card insertion opening through which a chip card is inserted into the card reader up to its data exchange position.

9. The card reader according to claim 1, wherein the card reader is mounted on a printed circuit board which makes electrical contact with the drilling protection conductor track structure.

10. The card reader according to claim 1, wherein the drilling protection conductor track structure has at least one drilling protection conductor track with a line thickness of at most 0.15 mm, and with a line spacing of at most 0.2 mm.

11. A drilling protection cover composed of plastic, comprising:
a plastic back-moulded conductor track foil which has an area-covering drilling protection conductor track structure;
wherein the drilling protection conductor track structure is applied and/or printed onto the conductor track foil using an electrically conductive, transparent ink.

12. The drilling protection cover according to claim 11, wherein the conductor track foil has a single-layer or multi-layer drilling protection conductor track structure which is in each case applied and/or printed onto a carrier layer or a protective layer of the conductor track foil.

13. The drilling protection cover according to claim 11, wherein the drilling protection conductor track structure has at least one drilling protection conductor track with a line thickness of at most 0.2 mm, and with a line spacing of at most 0.3 mm.

14. The drilling protection cover according to claim 11, wherein the at least one drilling protection conductor track, at its ends, has in each case electrical connection contacts, in particular in the form of exposed electrical contact areas.

15. The drilling protection cover according to claim 11, wherein the drilling protection cover is designed as a drilling protection hood, the hood inner side and/or hood outer side of the said drilling protection hood being formed by the conductor track foil.

16. The drilling protection cover according to claim 11, wherein the drilling protection conductor track structure has at least one drilling protection conductor track with a line thickness of at most 0.15 mm, and with a line spacing of at most 0.2 mm.
